(19) United States
(12) Patent Application Publication
(10) Pub. No.: US 2022/0279790 A1
(43) Pub. Date: Sep. 8, 2022

(54) HIGH-CONCENTRATION FLUENSULFONE FORMULATIONS, THEIR USES AND PROCESSES OF PREPARATION

(71) Applicant: ADAMA MAKHTESHIM LTD., Beer Sheva (IL)

(72) Inventors: Michael Berkovitch, Ashdod (IL); Gilad Silbert, Kibutz Dorot (IL)

(73) Assignee: ADAMA MAKHTESHIM LTD., Beer Sheva (IL)

(21) Appl. No.: 17/698,451

(22) Filed: Mar. 18, 2022

Related U.S. Application Data
(63) Continuation of application No. 16/467,355, filed on Jun. 6, 2019, now abandoned.
Application No. 16/467,355 is a continuation-in-part of application No. PCT/IB2016/001863, filed on Dec. 9, 2016.
(60) Provisional application No. 62/517,391, filed on Jun. 9, 2017.

(51) Int. Cl. A01N 43/78; A01N 25/04; A01N 25/30; A01N 35/04

(52) U.S. Cl. CPC A01N 43/78; A01N 25/04; A01N 25/30; A01N 35/04

(57) ABSTRACT

The subject invention provides stable liquid fluensulfone formulations comprising an amount of fluensulfone, an amount of a cyclic ketone, and at least one agrochemically acceptable inert additive. The subject invention also provides high-concentration formulations comprising fluensulfone and at least one agrochemically acceptable inert additive, wherein the formulation comprises an organic phase and the concentration of fluensulfone in the organic phase of the formulation is greater than 40% by weight. The subject invention also provides methods of controlling a pest using the fluensulfone formulations described herein. The present invention provides processes of preparing the fluensulfone formulations described herein.

This application claims benefit of U.S. Provisional Application No. 62/517,391, filed Jun. 9, 2017, the entire content of which is hereby incorporated by reference herein.

This application also claims benefit of PCT International Application No. PCT/IB2016/001863, filed Dec. 9, 2016, the entire content of which is hereby incorporated by reference herein.

Throughout this application, various publications are cited. Disclosures of the documents and publications referred to herein are hereby incorporated in their entireties by reference into this application.

### BACKGROUND

Nematodes are agricultural pests that attack a wide range of crops, including common vegetables, field crops, fruit trees and ornamentals. Nematodes are difficult to control and they spread easily from area to area through soil, tools or infested plants.

Fluensulfone (5-chloro-2-(3,4,4-trifluorobut-3-enylsulfonyl)-1,3-thiazole; CAS No. 318290-98-1) is a fluoroalkenyl thioether nematicide which has a significantly lower environmental impact compared to other currently available nematicides due to its low toxicity to non-target insects and mammals. Fluensulfone's mode of action is also distinct from other currently available nematicides and therefore presents a promising entity for crop protection.

All target nematodes are essentially aquatic animals, which live and move in fluids. Soil nematodes live in water films surrounding soil particles. Commercially available fluensulfone formulations are first mixed with water and then applied in the field as foliar sprays or by through irrigation methods. In order to be effective for controlling nematodes, fluensulfone should be delivered to water films surrounding soil particles where plant feeding nematodes live.

Fluensulfone is currently available in emulsifiable concentrate (EC) and granule (GR) formulations. In order to prepare the emulsifiable concentrate fluensulfone formulation, it is necessary to dissolve the fluensulfone in an appropriate organic solvent and add surfactants so that the solution will form an oil-in-water emulsion when added to water.

Disclosed herein is a new formulation of fluensulfone.

### SUMMARY OF THE PRESENT SUBJECT MATTER

Generally, the present subject matter relates to formulations with high-concentrations of fluensulfone in the organic phase of the formulation.

The subject invention is based on a surprising finding that addition of cyclic ketones to fluensulfone depresses the melting point of the mixture which significantly decreases the amount of organic solvent necessary to form a homogeneous liquid mixture comprising fluensulfone. This allows for formulations with high-concentrations of fluensulfone in the organic phase.

It is extremely surprising that fluensulfone in the organic phase of the high-concentration formulations according to the invention does not crystallize out when diluted with water. In particular, the presence of cyclic ketone prevents fluensulfone in the high-concentration formulation in the spray liquor from crystallizing out.

The subject invention provides a stable liquid formulation comprising:
(i) an amount of fluensulfone,
(ii) an amount of a cyclic ketone, and
(iii) at least one agrochemically acceptable inert additive.

The subject invention also provides a stable liquid high-concentration formulation comprising an amount of fluensulfone and at least one agrochemically acceptable inert additive, wherein the formulation has an organic phase and the concentration of fluensulfone in the organic phase of the formulation is greater than 40% by weight.

The subject invention also provides a stable liquid high-concentration formulation comprising an amount of fluensulfone and at least one agrochemically acceptable inert additive, wherein the formulation has an organic phase and the concentration of fluensulfone in the organic phase of the formulation is greater than 76% by weight.

The subject invention also provides a method of controlling a pest comprising applying the fluensulfone formulations described herein to the pest, juveniles of the pest or eggs or cysts of the pest, or to a medium in which the pest, the juveniles of the pest or the eggs or cysts of the pest is capable of being present thereby controlling the pest.

The present invention also provides a method of controlling a pest comprising:
(i) obtaining a stable liquid high-concentration formulation comprising an amount of fluensulfone and at least one agrochemically acceptable inert additive, wherein the formulation has an organic phase and the concentration of fluensulfone in the organic phase of the formulation is greater than 40% by weight, and
(ii) applying the high-concentration formulation to the pest, juveniles of the pest or eggs or cysts of the pest, or to a medium in which the pest, the juveniles of the pest or the eggs or cysts of the pest is capable of being present thereby controlling the pest.

The present invention also provides a method of controlling a pest comprising:
(i) obtaining a stable liquid high-concentration formulation comprising an amount of fluensulfone and at least one agrochemically acceptable inert additive, wherein the formulation has an organic phase and the concentration of fluensulfone in the organic phase of the formulation is greater than 76% by weight, and
(ii) applying the high-concentration formulation to the pest, juveniles of the pest or eggs or cysts of the pest, or to a medium in which the pest, the juveniles of the pest or the eggs or cysts of the pest is capable of being present thereby controlling the pest.

The subject invention also provides a process of preparing the stable liquid formulations described herein comprising the steps of:
(i) preparing a homogenous mixture comprising the amount of fluensulfone and the amount of the cyclic ketone, and
(ii) mixing the homogenous mixture with the at least one agrochemically acceptable inert additive to form a stable liquid fluensulfone formulation.

The present invention provides a process of preparing an oil-in-water formulation described herein comprising the steps of:
(i) preparing a first homogenous mixture comprising the amount of fluensulfone and the amount of the cyclic ketone,
(ii) preparing a second homogenous mixture comprising water and the at least one agrochemically acceptable inert additive, and
(iii) mixing the first homogenous mixture and the second homogenous mixture to form a high-concentration fluensulfone formulation.

### DETAILED DESCRIPTION OF THE PRESENT SUBJECT MATTER

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

### Definitions

As used herein, the phrase “high-concentration” when used in connection with an active substance means that the active substance has a concentration in the organic phase of the formulation of more than 40% by weight.

As used herein, the term “stable” when used in connection with a formulation means that no crystallization of the active ingredient in the formulation is observable after at least 2 weeks of storage at temperatures of 0° C., 4° C., 40° C. and/or 54° C.

As used herein, the term “free of” when used in connection with a compound means that the compound was not affirmatively added to a formulation.

The term “a” or “an” as used herein includes the singular and the plural, unless specifically stated otherwise. Therefore, the terms “a,” “an” or “at least one” can be used interchangeably in this application.

As used herein, term “about” when used in connection with a numerical value includes ±10% from the indicated values. In addition, the endpoints of all ranges directed to the same component/moiety/ or property herein are inclusive of the endpoints, are independently combinable, and include all intermediate points and ranges.

It is understood that where a parameter range is provided, all integers within that range, and tenths thereof, are also provided by the invention.

All publications, patents and patent applications mentioned in this specification are herein incorporated in their entirety by reference into the specification, to the same extent as if each individual publication, patent or patent application was specifically and individually indicated to be incorporated herein by reference.

The subject invention provides a stable liquid fluensulfone formulation comprising:
(i) an amount of fluensulfone,
(ii) an amount of a cyclic ketone, and
(iii) at least one agrochemically acceptable inert additive.

In some embodiments, the amount of fluensulfone in the formulation is in liquid state.

In some embodiments, the cyclic ketone is selected from a group consisting of acetophenone, cyclohexanone, N-octyl-2-pyrrolidone, and any mixture thereof. In some embodiments, the cyclic ketone is acetophenone and/or cyclohexanone. In some embodiments, the cyclic ketone is acetophenone.

In some embodiments, the concentration of cyclic ketone in the formulation is from about 1% to about 30% by weight of the total formulation. In some embodiments, the concentration of cyclic ketone in the formulation is from about 5% to about 20% of by weight of the total formulation. In some embodiments, the concentration of cyclic ketone in the formulation is from about 10% to about 15% by weight of the total formulation.

In some embodiments, the concentration of cyclic ketone in the formulation is from about 10 g/L to about 300 g/L of the total formulation. In some embodiments, the concentration of cyclic ketone in the formulation is from about 50 g/L to about 250 g/L of the total formulation. In some embodiments, the concentration of cyclic ketone in the formulation is from about 100 g/L to about 200 g/L of the total formulation. In some embodiments, the concentration of cyclic ketone in the formulation is about 130 g/L of the total formulation. In some embodiments, the concentration of cyclic ketone in the formulation is about 190 g/L of the total formulation.

In some embodiments, the weight ratio of the cyclic ketone to the fluensulfone in the formulation is from about 1:1 to about 1:8. In some embodiments, the weight ratio of the cyclic ketone to the fluensulfone in the formulation is from about 1:1 to about 1:5. In some embodiments, the weight ratio of the cyclic ketone to the fluensulfone in the formulation is from about 1:1 to about 1:3. In some embodiments, the weight ratio of the cyclic ketone to the fluensulfone in the formulation is about 1:3.

In some embodiments, the formulation has an organic phase which comprises from about 45% to 100% of the total formulation by weight. In some embodiments, the formulation has an organic phase which comprises from about 50% to about 90% of the total formulation by weight. In some embodiments, the formulation has an organic phase which comprises from about 60% to about 80% of the total formulation by weight. In some embodiments, the formulation has an organic phase which comprises about 70% of the total formulation by weight.

In some embodiments, the concentration of fluensulfone in the organic phase of the formulation is greater than 40% by weight. In some embodiments, the concentration of fluensulfone in the organic phase of the formulation is less than about 76% by weight. In some embodiments, the concentration of fluensulfone in the organic phase of the formulation is greater than about 76% by weight. In some embodiments, the concentration of fluensulfone in the organic phase of the formulation is from about 41% to about 90% by weight. In some embodiments, the concentration of fluensulfone in the organic phase of the formulation is from about 50% to about 80% by weight. In some embodiments, the concentration of fluensulfone in the organic phase of the formulation is from about 55% to about 75% by weight. In some embodiments, the concentration of fluensulfone the organic phase of the formulation is from about 65% to about 75% by weight. In some embodiments, the concentration of fluensulfone in the organic phase of the formulation is from about 75% to 85% by weight.

In some embodiments, the concentration of the cyclic ketone in the organic phase of the formulation is about 5% to about 30% by weight. In some embodiments, the concentration of the cyclic ketone in the organic phase of the formulation is about 5% to about 10% by weight. In some embodiments, the concentration of the cyclic ketone in the organic phase of the formulation is about 10% to about 15% of the by weight. In some embodiments, the concentration of the cyclic ketone in the organic phase of the formulation is about 15% to about 20% by weight. In some embodiments, the concentration of the cyclic ketone in the organic phase of the formulation is about 20% to about 25% by weight. In some embodiments, the concentration of the cyclic ketone in the organic phase of the formulation is about 25% to about 30% by weight.

In some embodiments, the at least one agrochemically acceptable inert additive is selected from the group consisting of adjuvants, surfactants, stabilizers, antioxidants, polymers, anti-thickening agents, antifreeze agents, antifoaming agents, colorants, ultraviolet light absorbers, antibacterial agents, salts, pH modifiers, co-solvents, humectants, and any combination thereof.

Examples of surfactants are ionic (anionic or cationic) and nonionic surfactants. Usually, the emulsion according to the invention comprises at least one surfactant.

Suitable nonionic surfactants all substances of this type which can usually be employed in agrochemical compositions, such as polyoxyethylene octyl phenol ethers, alkoxylated alcohols such as ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-derived sulfonates, polysaccharides (for example methylcellulose), hydrophobically modified starches, silicon-based surfactants, polyvinyl alcohol and its derivatives, polyalkoxylates, polyvinylamines polyvinylpyrrolidone and their copolymers or block polymers and the mixtures thereof.

Preferred nonionic surfactants are selected from the group consisting of castor oil ethylene oxides, poly(vinyl alcohol) (PVA), ethylene oxide/propylene oxide block copolymers and any combination thereof. In some embodiments, the nonionic surfactant is a castor oil ethylene oxide.

Suitable anionic surfactants are all substances of this type which can usually be employed in agrochemical compositions. Preference is given to alkali metal and alkaline earth metal salts of alkylsulphonic acids or alkylarylsulphonic acids and the mixtures thereof. A further preferred group of anionic surfactants or dispersants are salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde, salts of lignosulphonic acid, and the mixtures thereof. A more preferred group of anionic surfactants is block copolymers.

In some embodiments, the block copolymer is a linear block copolymer. In some embodiments, the block copolymer is a di-block copolymer or tri-block copolymer. In some embodiments, the block copolymer is a comb block copolymer.

In some embodiments, the block copolymer comprises an anchoring moiety and at least one stabilizing moiety.

In some embodiments, the anchoring moiety is a hydrophobic block copolymer. In some embodiments, at least 90% of the anchoring moiety is hydrophobic monomers. In some embodiments, the hydrophobic monomers is selected from the group consisting of acrylate derivatives, methacrylate derivatives, styrene derivatives, and any combination thereof. In some embodiments, the hydrophobic monomer is ethyl acrylate (EA).

In some embodiments, the at least one stabilizing moiety is a hydrophilic block copolymer. In some embodiments, at least 60% by weight of monomers in the stabilizing moiety are charged monomers. In some embodiments, less than 40% by weight of the monomers in the stabilizing moiety are neutral hydrophilic monomers. In some embodiments, the charged monomers are anionic monomers. In some embodiments, at least one of the anionic monomers has a sulfonate group. In some embodiments, at least one of the anionic monomers is 2-acrylamido-2-methylpropane sulphonate (AMPS). In some embodiments, the neutral hydrophilic monomer is selected from a group consisting of N-vinylpyrrolidone, ethylene oxide, glycoside acrylate, and acrylamide.

In some embodiments:
a) the block copolymer comprises up to 150 monomers,
b) the weight of the block copolymer is up to 31000 g/mol,
c) the weight of the stabilizing moiety is 5,000 to 100,000 g/mol,
d) the weight of the anchoring moiety is 500 to 5,000 g/mol,
e) the weight percentage of the stabilizing moiety is 65-90% of the total weight of the block copolymer.
f) the molar ratio of the anchoring moiety to the stabilizing moiety is 1:2-4, and/or
g) the concentration of the block copolymer in the composition is 0.2-3% w/w.

In some embodiments, the anionic surfactant is sodium 2-acryloylamino-2-methylpropane-1-sulfonate/ethyl acrylate block copolymers.

In some embodiments, the concentration of non-ionic surfactant is from about 5 g/L to about 80 g/L in the formulation. In some embodiments, the concentration of non-ionic surfactant is about 15 g/L in the formulation. In some embodiments, the non-ionic surfactant has a concentration of about 60 g/L in the formulation.

Suitable antifoaming agents are all substances which can usually be employed for this purpose in agrochemical compositions. Preference is given to silicone oils and magnesium stearate. In some embodiments, the antifoaming agent is a silicone antifoaming agent.

Suitable antioxidants are all substances which can usually be employed for this purpose in agrochemical compositions. Preference is given to butylated hydroxytoluene (2,6-di-t-butyl-4-methylphenol, BHT).

Suitable colorants are all substances which can usually be employed for this purpose in agrochemical compositions. Examples which may be mentioned are titanium dioxide, carbon black, zinc oxide and blue pigments and permanent red.

Suitable antifreeze agents are all substances of this type which can usually be employed in agrochemical compositions. Preference is given to urea, glycerol and propylene glycol. In some embodiments, the antifreeze agent is propylene glycol.

In some embodiments, one of the agrochemically acceptable inert additives is a pH modifier. In some embodiments, the pH modifier is hexamethylenetetramine (HMTA).

In some embodiments, the concentration of all the agrochemically acceptable inert additives in the formulation is about 5% to about 30% by weight of the total formulation. In some embodiments, the concentration of all the agrochemically acceptable inert additives in the formulation is about 15% to about 20% by weight of the total formulation.

In some embodiments, the concentration of all the agrochemically acceptable inert additives in the formulation is from about 5 g/L to about 30 g/L of the total formulation. In some embodiments, the concentration of all the agrochemically acceptable inert additives in the formulation is about from 15 g/L to about 20 g/L of the total formulation.

In some embodiments, the concentration of all the agrochemically acceptable inert additives in the formulation is from about 50 g/L to about 300 g/L of the total formulation. In some embodiments, the concentration of all the agrochemically acceptable inert additives in the formulation is about from 150 g/L to about 200 g/L of the total formulation.

In some embodiments, the formulation has a density of about 1 g/mL to about 1.5 g/mL. In some embodiments, the formulation has a density of about 1.1 g/mL to about 1.2 g/mL.

In some embodiments, the formulation has a pH of about 4.5 to about 7.5. In some embodiments, the formulation has a pH of about 5 to about 8.

In some embodiments, the formulation is an emulsifiable concentrate formulation (EC). In some embodiments, the formulation is an emulsion formulation. In some embodiments, the formulation is an oil-in-water emulsion formulation (EW).

In some embodiments, the cyclic ketone selected from a group consisting of cyclohexanone, N-octyl-2-pyrrolidone, and a mixture thereof. In some embodiments, the cyclic ketone is other than acetophenone.

In some embodiments, the agrochemically acceptable inert additive is other than a block copolymer. In some embodiments, the agrochemically acceptable inert additive is other than a diblock copolymer. In some embodiments, the agrochemically acceptable inert additive is other than a block copolymer comprising ethyl acrylate (EA) and 2-acrylamido-2-methylpropane sulphonate (AMPS) monomers. In some embodiments, the agrochemically acceptable inert additive is other than sodium 2-acryloylamino-2-methylpropane-1-sulfonate/ethyl acrylate block copolymer.

In some embodiments, the formulation is free of acetophenone.

In some embodiments, the formulation is free of block copolymer. In some embodiments, the formulation is free of diblock copolymer.

In some embodiments, the formulation is free of block copolymer comprising ethyl acrylate (EA) and 2-acrylamido-2-methylpropane sulphonate (AMPS) monomers. In some embodiments, the formulation is free of sodium 2-acryloylamino-2-methylpropane-1-sulfonate/ethyl acrylate block copolymer.

In some embodiments, the high-concentration formulation is other than an oil-in-water emulsion formulation comprising fluensulfone, acetophenone, 2, 6-di-tert-butyl-4-methylphenol, castor oil ethylene oxide, sodium 2-acryloylamino-2-methylpropane-1-sulfonate/ethyl acrylate block copolymer, ethoxylated polypropylene oxide, propylene glycol, silicone based antifoaming agent and water.

In some embodiments, the high-concentration formulation is other than an oil-in-water emulsion formulation comprising 51% by weight of fluensulfone, 16.8% by weight of acetophenone, 0.4% by weight of 2,6-di-tert-butyl-4-methylphenol, 1% by weight of castor oil ethylene oxide, 2.78% by weight of sodium 2-acryloylamino-2-methylpropane-1-sulfonate/ethyl acrylate block copolymer, 2.78% by weight of ethoxylated polypropylene oxide, 2.2% by weight of propylene glycol, 0.1% by weight of silicone based antifoaming agent and 23% by weight of water.

The subject invention also provides a stable liquid fluensulfone formulation consisting of:
(i) an amount of fluensulfone,
(ii) an amount of a cyclic ketone, and
(iii) at least one agrochemically acceptable inert additive.

The subject invention also provides a stable liquid fluensulfone formulation consisting essentially of:
(i) an amount of fluensulfone,
(ii) an amount of a cyclic ketone, and
(iii) at least one agrochemically acceptable inert additive.

The subject invention also provides a stable liquid high-concentration formulation comprising an amount of fluensulfone and at least one agrochemically acceptable inert additive, wherein the formulation has an organic phase and the concentration of fluensulfone in the organic phase of the formulation is greater than 40% by weight.

The subject invention also provides a stable liquid high-concentration formulation comprising an amount of fluensulfone and at least one agrochemically acceptable inert additive, wherein the formulation has an organic phase and the concentration of fluensulfone in the organic phase of the formulation is greater than 76% by weight.

The formulations according to the subject invention are stable even after prolonged storage at elevated temperatures or in the cold and no crystal growth is observed. By dilution with water, the formulations of the subject invention can easily be converted into homogeneous spray liquors for application.

The subject invention also provides a method of controlling a pest comprising applying the fluensulfone formulations described herein to the pest, juveniles of the pest or eggs or cysts of the pest, or to a surface on which the pest, the juveniles of the pest or the eggs or cysts of the pest is capable of being present thereby controlling the pest.

The present invention also provides a method of controlling a pest comprising:
(i) obtaining a stable liquid high-concentration formulation comprising an amount of fluensulfone and at least one agrochemically acceptable inert additive, wherein the formulation has an organic phase and the concentration of fluensulfone in the organic phase of the formulation is greater than 40% by weight, and
(ii) applying the formulation to the pest, juveniles of the pest or eggs or cysts of the pest, or to a medium on which the pest, the juveniles of the pest or the eggs or cysts of the pest is capable of being present thereby controlling the pest.

The present invention also provides a method of controlling a pest comprising:
(i) obtaining a stable liquid high-concentration formulation comprising an amount of fluensulfone and at least one agrochemically acceptable inert additive, wherein the formulation has an organic phase and the concentration of fluensulfone in the organic phase of the formulation is greater than 76% by weight, and
(ii) applying the formulation to the pest, juveniles of the pest or eggs or cysts of the pest, or to a medium on which the pest, the juveniles of the pest or the eggs or cysts of the pest is capable of being present thereby controlling the pest.

In some embodiments, the method is effective to kill the pest, the juvenile of the pest, or the egg or cyst of the pest.

In some embodiments, the pest, the juvenile of the pest, or the egg or cyst of the pest is killed within 24 hours after contact of the fluensulfone with the pest, the juvenile of the pest, or the egg or cyst of the pest.

In some embodiments, the pest, the juvenile of the pest, or the egg or cyst of the pest is killed within 48 hours after contact of the fluensulfone with the pest, the juvenile of the pest, or the egg or cyst of the pest.

In some embodiments, the method is effective to immobilize the pest or the juvenile of the pest.

In some embodiments, the pest or juvenile of the pest is immobilized within 24 hours after contact of fluensulfone with the pest or the juvenile of the pest. In some embodiments, the pest or juvenile of the pest is immobilized within 48 hours after contact of fluensulfone with the pest or the juvenile of the pest.

In some embodiments, the method improves growth of plants infested with nematodes treated with the fluensulfone formulation compared to growth of untreated plants infested with nematodes. Plant growth may be measured by number of plants, weight of plants, or any other known measures of plant growth. In some embodiments, the method improves root health of plants infested with nematodes treated with the fluensulfone formulation compared to growth of untreated plants infested with nematodes. Root health may be measured by the Galling Index or any other known measures for root health.

In some embodiments, the formulation is applied at a rate of about 0.01 kg/ha to about 8 kg/ha of fluensulfone. In some embodiments, the formulation is applied at a rate of about 0.5 kg/ha to about 5 kg/ha of fluensulfone. In some embodiments, the formulation is applied at a rate of about 1 kg/ha to about 3 kg/ha of fluensulfone.

In some embodiments, the formulation is applied at a rate of about 1 g to about 50 g of fluensulfone per 100 kg of seeds. In some embodiments, the formulation is applied at a rate of about 1 g to about 5 g of fluensulfone per 100 kg of seeds. In some embodiments, the formulation is applied at a rate of about 1 g of fluensulfone per 100 kg of seeds. In some embodiments, the formulation is applied at a rate of about 5 g of fluensulfone per 100 kg of seeds. In some embodiments, the formulation is applied at a rate of about 25 g to about 35 g of fluensulfone per 100 kg of seeds.

In some embodiments, the formulation is diluted with an amount of water prior to application. In some embodiments, the amount of water is 10 to 10,000 times the amount of the formulation by volume.

In some embodiments, the pest is a plant pest. In some embodiments, the plant pest is a nematode.

In some embodiments, the nematode is Reniform nematode, Rotlyenchulus spp.; Dagger nematode, Xiphinema spp.; Lance nematode, Hoplolaimus spp.; Pin nematode, Paratylenchus spp.; Ring nematode, Criconemoides spp.; Root knot nematode, Meloidogyne spp.; Sheath nematode, Hemicycliophora spp.; Spiral nematode, Helicotylenchus spp.; Stubby root nematode, Trichodorus spp.; Cyst nematode, Heterodera spp.; Sting nematode, Belonolaimus, spp.; and/or Stunt nematode, Tylenchorhynchus spp.

In some embodiments, the nematode is Heterodera glycines. In some embodiments, the nematode is Meloidogyne incognita. In some embodiments, the nematode is Meloidogyne javanica.

The present invention also provides a process of preparing the formulations described herein, wherein the process comprises the steps of:
(i) preparing a homogenous mixture comprising the amount of fluensulfone and the amount of the cyclic ketone, and
(ii) mixing the homogenous mixture with the at least one agrochemically acceptable inert additive to form a stable liquid fluensulfone formulation.

In some embodiments, the formulation is prepared under a temperature between 15° C. to 70° C.

The subject invention also provides a process for preparing the stable oil-in-water emulsion formulation described herein, wherein the process comprises the steps of:
(i) preparing a first homogenous mixture comprising the amount of fluensulfone and the amount of the cyclic ketone,
(ii) preparing a second homogenous mixture comprising water and the at least one agrochemically acceptable inert additive, and
(iii) mixing the first homogenous mixture and the second homogenous mixture to form the stable oil-in-water emulsion fluensulfone formulation.

In some embodiments, step (i) is performed at a temperature between 45° C. to 50° C. In some embodiments, the first homogenous mixture further comprises an antioxidant. In some embodiments, the antioxidant is 2,6-di-tert-butyl-4-methylphenol (BHT). In some embodiments, the first homogenous mixture further comprises a non-ionic surfactant. In some embodiments, the non-ionic surfactant is castor oil ethylene oxide.

In some embodiments, step (ii) is performed at a temperature between 80° C. to 85° C. In some embodiments, the agrochemically acceptable inert additive is an emulsifier. In some embodiments, the emulsifier is polyvinyl alcohol (PVA). In some embodiments, the PVA is mixed with the water until the PVA is dissolved. In some embodiments, the agrochemically acceptable inert additive is an antifreeze agent. In some embodiments, the antifreeze agent is propylene glycol. In some embodiments, the agrochemically acceptable inert additive is an antifoam agent. In some embodiments, the agrochemically acceptable inert additive is a pH modifier. In some embodiments, the pH modifier is hexamethylenetetramine (HMTA). IN some embodiments, the agrochemically acceptable inert additive is mixed with the water until the agrochemically acceptable inert additive is dissolved.

In some embodiments, step (iii) is performed under high shear. In some embodiments, high shear is continued until a mean droplet size of about 0.1 μm to about 5 μm is reached. In preferred embodiments, the mean droplet size is about 0.3 μm to about 3 μm. In more preferred embodiments, the mean droplet size is about 0.5 to about 2 μm. In some embodiments, the mean droplet size is about 1 μm, preferably of about 1.5 μm, more preferable of about 2 μm.

In some embodiments, the amount of fluensulfone is liquefied in the process of preparation of the formulation.

Each embodiment disclosed herein is contemplated as being applicable to each of the other disclosed embodiments. Thus, all combinations of the various elements described herein are within the scope of the invention. In addition, the elements recited in formulation embodiments can be used in the method and process embodiments described herein and vice versa.

### EXAMPLES

Examples are provided below to facilitate a more complete understanding of the present subject matter. The following examples illustrate the exemplary modes of making and practicing the present subject matter. However, the scope of the present subject matter is not limited to specific embodiments disclosed in these Examples, which are for purposes of illustration only. Other embodiments will be apparent to one skilled in the art from consideration of the specification and examples. It is intended that the specification, including the examples, is considered exemplary only without limiting the scope and spirit of the present subject matter.

### Example 1a

### High-Concentration Fluensulfone Oil-in-Water Emulsion, Formulation A

In this example, a high-concentration oil-in-water emulsion containing 635 g/L of fluensulfone (74% fluensulfone in organic phase) is presented in Table 1 below.

TABLE 1
Organic Phase (A)

| | | | % of Total | |
|---|---|---|---|---|
| Components | Manufacturer | Description | Formulation | Amount (g) |
| Fluensulfone Tech. | Adama | Active ingredient | 51.0 | 635.0 |
| | Makhteshim | | | |
| Acetophenone | Rutgers | Solvent | 16.8 | 208.7 |
| Ionol ® CP | Oxiris | 2,6-di-tert-butyl-4- | 0.4 | 4.8 |
| | | methylphenol; | | |
| | | Anti-oxidant | | |
| CO-20 (Berol 829) | AkzoNobel | Castor oil ethylene | 1.0 | 12.5 |
| | | oxide; | | |
| | | Non-ionic surfactant | | |

| | | |
|---|---|---|
| Total Organic Phase | 69.1 | 860.9 |

Water phase (B)

| Components | Manufacturer | Description | % | Gram |
|---|---|---|---|---|
| PolyAgro B2 | Solvay | AMPS-EA di-block | 2.78 | 34.5 |
| | | copolymer (2Da- | | |
| | | 10Da); | | |
| | | Approx. 30% aqueous | | |
| | | solution | | |
| Synperonic ™ | Croda | Ethoxylated | 2.78 | 34.5 |
| | | polypropylene oxide | | |
| PE/L64 | | | | |
| Propylene glycol | Ineos | | 2.2 | 27.4 |
| SAG 1572 | Momentive | Siliconanti-foam | 0.1 | 0.8 |
| | | emulsion | | |
| Soft water | | Solvent | 23.0 | 286.9 |

| | | |
|---|---|---|
| Total Water Phase | 30.9 | 384.2 |
| Total Formulation | 100.0 | 1245.1 |

### Organic Phase A:

Fluensulfone tech. was melted and charged to the vessel. The vessel was heated to 45° C.-50° C. and acetophenone, Ionol® CP and CO-20(Berol 829) were added and mixed until a homogeneous solution was obtained. The solution was filtered to remove any solid contaminations.

### Water Phase B:

Soft water was charged to the vessel. Then Synperonic PE/L 64, PolyAgro B2, Propylene glycol and SAG 1572 were added to the vessel and mixed until a homogeneous solution was obtained.

### Emulsification:

Organic Phase A was charged to the Water Phase B slowly while under high shear. The high shear was continued until droplet size of about D90=2 μm was reached.

### Example 1b

### High-Concentration Fluensulfone Oil-in-Water Emulsion, Formulation B

In this example, a high-concentration oil-in-water emulsion containing 655 g/L of fluensulfone (75.5% fluensulfone in organic phase) is presented in Table 2 below.

TABLE 2
Organic Phase (A)

| | | | % of Total | |
|---|---|---|---|---|
| Components | Manufacturer | Description | Formulation | Amount (g) |
| FluensulfoneTech. | Adama | Active ingredient | 52.3 | 657 |
| (99.7%) | Makhteshim | | | |
| Acetophenone | Rutgers | Solvent | 15.4 | 193 |
| Ionol ® CP | Oxiris | 2,6-di-tert-butyl-4- | 0.4 | 5 |
| | | methylphenol; | | |
| | | Anti-oxidant | | |
| CO-20 (Berol 829) | AkzoNobel | Castor oil ethylene | 1.0 | 12.9 |
| | | oxide; | | |
| | | Non-ionic | | |
| | | surfactant | | |

| | | |
|---|---|---|
| Total Organic Phase | 69.1 | 867.9 |

Water phase (B)

| Components | Manufacturer | Description | % | Gram |
|---|---|---|---|---|
| PolyAgro B2 | Solvay | AMPS-EA di-block | 2.8 | 35.2 |
| | | copolymer (2Da- | | |
| | | 10Da); | | |
| | | Approx.30% | | |
| | | aqueous solution | | |
| Synperonic ™ PE/L64 | Croda | Ethoxylated | 2.8 | 35.2 |
| | | polypropylene | | |
| | | oxide | | |
| HMTA | CALDIC | | 0.9 | 11.4 |
| (Hexamethylenetetramine) | CHEMIE B.V | | | |
| SAG 1572 | Momentive | Silicon anti-foam | 0.1 | 0.8 |
| | | emulsion | | |
| Soft water | | Solvent | 24.3 | 304 |

| | | |
|---|---|---|
| Total Water Phase | 30.9 | 386.6 |
| Total Formulation | 100.0 | 1254 |

### Organic Phase A:

Fluensulfone tech. was melted and charged to the vessel. The vessel was heated to 45° C.-50° C. and acetophenone, Ionol® CP and CO-20 (Berol 829) were added and mixed until a homogeneous solution was obtained. The solution was filtered to remove any solid contaminations.

### Water Phase B:

Soft water was charged to the vessel. Then Synperonic PE/L 64, PolyAgro B2 and SAG 1572 were added to the vessel and mixed until a homogeneous solution was obtained.

### Emulsification:

Organic Phase A was charged to the Water Phase B slowly while under high shear. The high shear was continued until droplet size of about D90=2 μm was reached.

### HMTA Addition

The HMTA was added gradually while mixing with low shear. PolyAgro B2 used in the above high-concentration fluensulfone oil-in-water emulsion is a polyelectrolyte-layer forming block copolymer formulation. The composition of PolyAgro B is represented below in Table 3.

TABLE 3

| | | | | Total | STAB | ANCHOR | | |
|---|---|---|---|---|---|---|---|---|
| AMPS | EA | AMPS | EA | Mnth | Mnth | Mnth | DPn | DPn |
| (mol %) | (mol %) | (wt %) | (wt %) | (g/mol) | (g/mol) | (g/mol) | STAB | ANCHOR |
| 69 | 31 | 83.3 | 16.7 | 12,000 | 10,000 | 2,000 | 44 | 20 |

The polyelectrolyte-layer forming block copolymer is a di-block copolymer, with a total weight of 12000 g/mol, composed of a hydrophobic block (Anchor block- ANCHOR) and a hydrophilic block (Stabilizing block—STAB). The stabilizing, hydrophilic, block is made of sodium 2-Acryloylamino-2-methylpropane-1-sulfonate (AMPS) monomers, which are 69% of the overall monomers in the polymer.

The other 31% of the monomers belongs to the anchor, hydrophobic, block which is made of ethyl acrylate monomers. The total amount of monomers in the polymer (degree of polymerization, DPn) is 64 monomers.

Such polymer may be obtained from Rhodia Operations, a corporation of Paris, France, a member of the SOLVAY Group.

Such polymer may also be prepared as described in PCT International Application No. PCT/IB2016/001863. PCT International Application No. PCT/IB2016/001863 was applied by Rhodia Operations, a member of the SOLVAY Group, and Adama Makhteshim Ltd. As described in PCT International Application No. PCT/IB2016/001863, the polyelectrolyte-layer forming block copolymer used in the formulations of the subject invention may be prepared according to the following procedure.

a) Macro CTA

Into a 2L double jacketed reactor equipped with mechanical agitator and reflux condenser was added 14.9g of O-ethyl-S-(1-methoxycarbonylethyl)xanthate (CH3CH(CO2CH3))S(C═S)OEt), 266.2 g of Ethanol, and 364.7 g of De-ionized water and 1400 g of AMPS(Na) solution (50% active) and 1.7 g of sodium persulfate. The reactor contents were heated to 70° C. under agitation and nitrogen. The reaction mixture was aged at 70° C. for a further hour whereupon it was cooled to ambient temperature and discharged. The measured solids content was 38% (115° C., 60 min).

b) Chain Extension

Into a 2 L double jacketed reactor equipped with mechanical agitator and reflux condenser was added 1314.8 g of macro CTA solution (see a) and 283 g of de-ionized water. The reactor content was heated to 70° C. under agitation and nitrogen at 70° C. start add 100 g of ethyl acrylate (EA) over 2H00 and 24.8 g of a solution of 12 wt % of sodium persulfate over 2h30. After the end of the introduction of the initiator solution, aged for one hour. Add in one shot 14.3 g of a solution 12 wt % of sodium persulfate and aged at 70° C. for a further hour whereupon it was cooled to ambient temperature and discharged. The measured solids content was 35.4% (115° C., 60 min).

Ethanol was removed from the polymer solution using a rotary evaporator. Water was back added to achieve a polymer solution with a final solids content of 35.8%.

1101 g of stripped polymer solution was placed in a 2 L double jacketed reactor equipped with mechanical agitator and reflux condenser. The pH of the solution was increased to 8.5 using 105 g of a 5wt % (NaHCO3/Na2CO3 50/50 mol %) buffer solution and 87.8 g of de-ionized water. The mixture was heated to 70° C. with stirring whereupon 35.8 g of a 30% solution of hydrogen peroxide was added in 1 hour at the end of the additions, the solution was aged for a further 3h00 whereupon it was cooled and discharged. The measured solids content was 32.2%. (PCT/IB2016/001863)

### Example 2

### High-Concentration Fluensulfone Oil-in-Water Emulsion, Formulation C, and Preparation Thereof

In this example, an oil-in-water emulsion containing 380 g/L of fluensulfone (66% of fluensulfone in organic phase) is presented in Table 4 below.

TABLE 4

| | | | Quantity (Kg) |
|---|---|---|---|
| Raw Material | CAS No. | Function | for 1000 liters |
| Fluensulfone tech. (98%) | 318290-98-1 | Active | 380 kg as 100% |
| | | Ingredient | |
| Acetophenone | 98-86-2 | Solvent | 130.0 |
| Ionol® CP - Butylated | 128-37-0 | Stabilizer | 3.0 |
| Hydroxy Toluene (BHT) | | | |
| CO-20 (Berol 829)- | 61791-12-6 | Emulsifier | 60.0 |
| castor oil ethoxylated | | | |
| (20 mols EO) | | | |
| Mowiol® 4-88 (PVA) | 25213-24-5 | Emulsifier | 56.0 |
| Synperonic™ PE/L 64 | Proprietary | Emulsifier | 5.0 |
| Propylene glycol | 57-55-6 | Antifreeze | 50.0 |
| Rhodorsil® R432 | Proprietary | antifoam | 5.0 |
| | | agent | |
| HMTA | 100-97-0 | pH modifier | 10.0 |
| (Hexamethylenetetramine) | | | |
| Soft water | N. A. | Solvent | Up to 1000 L |
| | | | (about 453kg) |

### Organic Phase A:

Fluensulfone tech. was melted and charged to the vessel. The vessel was heated to 45° C.-50° C. and acetophenone, Ionol® CP and CO-20 (Berol 829) were added and mixed until a homogeneous solution was obtained. The solution was filtered to remove any solid contaminations.

### Water Phase B:

Soft water was charged to the vessel. Mowiol® 4-88 (PVA) was also charged to the vessel. The vessel was heated to 80° C.-85° C. The PVA was mixed with the soft water until all of the PVA dissolved. The vessel was cooled to room temperature and Synperonic™ PE/L 64, propylene glycol and HMTA (hexamethylenetetramine) were added and mixed until a homogeneous solution was obtained. Rhodorsil® R432 was then added to the vessel and mixed until a homogeneous solution was obtained.

### Emulsification:

Organic Phase A was charged to the Water Phase B slowly while under high shear. The high shear was continued until droplet size of about 0.5 μm was reached.

### Example 3

### Stability of High-Concentration Fluensulfone Oil-in-Water Emulsion (Formulation C)

To evaluate the stability of the high-concentration fluensulfone Formulation C, an accelerated storage stability test was conducted. Specifically, the formulation was stored for 2 weeks at room temperature and at temperatures of 4° C. and 54° C. and for two months at 40° C.

The results of the accelerated stability tests are summarized in

Table 5 below.

TABLE 5

| | Standard | | | | |
|---|---|---|---|---|---|
| | Acceptable | | | | Oven 40° C. |
| | limits | Room | Oven 54° C. | Cold 4° C. | 2 months |
| Appearance | white milky | white milky | white milky | white milky | white milky |
| | emulsion | emulsion | emulsion | emulsion | emulsion |
| Fluensulfone | 360-400 g/L | 380 g/L | 382 g/L | 380 g/L | 381 g/L |
| Concentration | | | | | |
| Density, g/ml | 1.1-1.2 g/mL | 1.165 g/mL | 1.165 g/mL | 1.165 g/mL | 1.165 g/mL |
| pH (l%) | 4.5-7.5 | 6.8 | 6.6 | 6.8 | 6.7 |
| Emulsion Stability | stable | stable | stable | stable | stable |
| dilution 1:1 | | | | | |
| Wet Sieve residue | no | no | no | no | no |
| test 45 p after | crystallization | crystallization | crystallization | crystallization | crystallization |
| dilution 1:1 (room | | | | | |
| temperature) | | | | | |

### Example 4

### Evaluation of Nematicidal Activity of High-Concentration Fluensulfone Formulations Against Meloidogyne incognita

M. incognita J2 were used to evaluate in-vitro the nematicidal activity of the high-concentration fluensulfone formulations of the subject invention, and to compare activities of fluensulfone when applied in the high-concentration formulations of the subject invention to activities of fluensulfone when applied in a solubilized liquid formulation at the same rate of application of fluensulfone.

### Material and Methods

Water-diluted 0.5 ml solutions of fluensulfone formulations shown below in Table 6, at 0, 1, 2, 4, 8 and 16 mg a.i./L were poured into 24-Well plates. Final concentrations of 0, 0.5, 1, 2, 4, and 8 mg fluensulfone per liter were obtained by adding 0.5 ml nematode suspension (containing ca. 150 M. incognita J2) to each well. The plates were kept at 25° C. for 48 h in an incubator. Percentages of immobile nematodes were recorded after 24 and 48 h exposure. After the 48-h exposure, nematodes were rinsed with tap water several times and incubated in the water for another 24 h. Percentages of immobile nematodes were recorded again. Each treatment had 4 replicates and the experiment was performed twice.

The fluensulfone formulations used are summarized in Table 6 below.

Table 6

| Formulation Name | Formulation Type | Fluensulfone, g/L |
|---|---|---|
| 480EC | Emulsifiableconcentrate | 480 |
| | (EC) | |
| 655EW | Oil-in-water emulsion (EW) | 655 |
| 380EW | Oil-in-water emulsion (EW) | 372.32 |
| 15SL | Soluble liquid (SL, | 15 |
| | Fluensulfone soluble in | |
| | water-based solution) | |

### Results

The nematicidal activity of the fluensulfone formulations of Table 6 against Meloidogyne incognita is summarized below in Tables 7-9.

TABLE 7
Percentage of immobilized Meloidogyne incognita juveniles
exposed to formulations of fluensulfone at concentrations
of 0, 0.5, 1, 2, 4 and 8 mg/L 24 h after exposure.

| | 0 mg/L | 0.5 mg/L | 1 mg/L | 2 mg/L | 4 mg/L | 8 mg/L |
|---|---|---|---|---|---|---|
| 480EC | 4.3 ± 1.8 | 38.9 ± 6.0 | 71.3 ± 3.3 | 84.8 ± 1.6 | 88.9 ± 3.6 | 89.8 ± 1.5 |
| 655EW | 4.4 ± 0.8 | 40.9 ± 3.3 | 77.9 ± 4.2 | 84.0 ± 6.3 | 92.3 ± 1.1 | 94.2 ± 3.2 |
| 380EW | 5.7 ± 2.6 | 45.8 ± 4.8 | 72.4 ± 2.5 | 84.8 ± 6.6 | 87.4 ± 2.7 | 89.6 ± 2.4 |
| 15SL | 2.7 ± 1.9 | 11.7 ± 0.8 | 16.2 ± 1.1 | 22.6 ± 3.1 | 36.8 ± 2.9 | 63.9 ± 4.9 |

(Values are expressed with their Standard Deviation)

TABLE 8
Percentage of immobilized Meloidogyne incognita juveniles
exposed to formulations of fluensulfone at concentrations
of 0, 0.5, 1, 2, 4 and 8 mg/L 48 h after exposure.

| | 0 mg/L | 0.5 mg/L | 1 mg/L | 2 mg/L | 4 mg/L | 8 mg/L |
|---|---|---|---|---|---|---|
| 480EC | 4.3 ± 1.8 | 86.1 ± 1.0 | 89.6 ± 1.5 | 92.4 ± 1.7 | 96.9 ± 0.8 | 98.1 ± 0.9 |
| 655EW | 6.2 ± 0.9 | 86.5 ± 4.4 | 86.3 ± 1.5 | 88.7 ± 2.8 | 93.2 ± 0.8 | 99.0 ± 0.9 |
| 380EW | 5.8 ± 0.4 | 79.1 ± 2.8 | 81.4 ± 6.7 | 86.9 ± 2.7 | 94.2 ± 0.6 | 96.4 ± 0.8 |
| 15SL | 4.4 ± 1.3 | 14.5 ± 4.8 | 22.6 ± 1.7 | 41.7 ± 4.5 | 72.9 ± 9.8 | 79.2 ± 1.5 |

(Values are expressed with their Standard Deviation)

TABLE 9
Percentage of immobilized Meloidogyne incognita juveniles
exposed to formulations of fluensulfone at concentrations
of 0, 0.5, 1, 2, 4 and 8 mg/L 24 h after rinsing in water

| | 0 mg/L | 0.5 mg/L | 1 mg/L | 2 mg/L | 4 mg/L | 8 mg/L |
|---|---|---|---|---|---|---|
| 480EC | 5.0 ± 1.0 | 91.8 ± 2.5 | 98.7 ± 0.5 | 97.8 ± 1.2 | 99.0 ± 0.4 | 100 ± 0 |
| 655EW | 5.8 ± 0.3 | 94.8 ± 0.8 | 98.1 ± 0.3 | 98.6 ± 0.6 | 99.8 ± 0.4 | 100 ± 0 |
| 380EW | 3.7 ± 1.4 | 93.5 ± 1.9 | 95.8 ± 1.7 | 97.5 ± 1.0 | 100 ± 0 | 100 ± 0 |
| 15SL | 2.9 ± 1.5 | 12.6 ± 3.0 | 30.6 ± 6.3 | 79.8 ± 3.9 | 92.3 ± 1.1 | 95.2 ± 1.5 |

(Values are expressed with their Standard Deviation)

### Conclusion

In-vitro trial results showed that both the 655EW and the 380EW formulations effectively immobilized nematodes at 24 hours after exposure, 48 hours after exposure, and 24 hours after rinse.

The results also showed that there is a post-action of fluensulfone after contact with nematodes. In particular, the percentage of immobilized nematodes at 24 hours after rinse was higher than the percentage of immobilized nematodes at 24 hours and 48 hours after exposure to the high-concentration fluensulfone formulations. The fact that the percentage of immobilized nematodes continued to rise after rinse suggests that the fluensulfone, which is in high concentration in the organic phase, efficiently diffused into the nematodes such that even the nematodes that survived initial contact got fluensulfone inside and were immobilized shortly after contact.

It was clearly shown that the SL formulation, in which all the fluensulfone is dissolved diluted in the aqueous phase rather than dissolved in concentrated droplets of solvent, is substantially less effective in all the tests. Moreover, the post-action of fluensulfone after rinse with water is reduced relative to both the 655EW and the 380EW formulation. Therefore, the results show advantage of delivery the same amount of fluensulfone in a heterogeneous way concentrated in the organic solvent droplets, as compared to its delivery homogenously diluted in the aqueous phase.

### Example 5

### Activity of High-Concentration Fluensulfone Formulations against Meloidogyne javanica J-2

In-vitro studies were conducted to determine the efficacy of the 380EW and 480EC formulations to control Meloidogyne javanica J-2 in tomato plants.

### Materials and Methods

380EW and 480EC were incorporated into soil at concentration of 0.5-2.0 mg A.I./L soil (see Table 10). Plastic pots (700 ml) were filled with treated and untreated (control) soil, and inoculated with 2,500 M. javanica juveniles per pot immediately. Tomato seedlings (cv. Daniela) were transplanted in the pots 7 days after inoculation. Each treatment had 7 replicates (pots). Fresh weight of shoot, galling index (0-5) and number of nematode eggs per plant were recorded 6 weeks after planting.

TABLE 10
Treatments in the Trials

| | Num. of | Concentration |
|---|---|---|
| | nematodes per | (mg A.1./L |
| Treatment | pot | soil) |
| Control (nematode | 0 | 0 |
| free) | | |
| Control (infested) | 2500 | 0 |
| 480EC | 2500 | 0.5 |
| 480EC | 2500 | 2 |
| 380EW | 2500 | 0.5 |
| 380EW | 2500 | 2 |

### Results

The nematicidal activity of the fluensulfone formulations of Table 9 against Meloidogyne javanica J-2 in tomato plants is summarized below in Tables 11-13.

TABLE 11
Effect of treatments with fluensulfone formulations
(480EC and 380EW) on tomato fresh shoot growth/weight.

| | | Fresh | | |
|---|---|---|---|---|
| | Concentration | shoot | | Student t |
| | (mg A. I./L | weight | Standard | statistical |
| Treatment | soil) | (gr) | Deviation | analysis* |
| Control | 0 | 17.1 | 2.9 | be |
| (nematode | | | | |
| free) | | | | |
| Control (infested) | 0 | 13.4 | 1.8 | e-g |
| 480EC | 0.5 | 14.3 | 3.2 | d-f |
| 480EC | 2 | 12.5 | 1.4 | g |
| 380EW | 0.5 | 16.7 | 1.6 | bc |

*letters denote statistical significance in outcome between the groups compared (p < 0.05).

TABLE 12
Effect of treatments with fluensulfone formulations
(480EC and 380EW) on galling index of tomato plants roots.

| | Concentration | Galling | | Student t |
|---|---|---|---|---|
| | (mg A. I . / L | index | St | statistical |
| Treatment | soil) | (0-5)* | Dev | analysis** |
| Control | 0 | | | |
| (nematode | | | | |
| free) | | | | |
| Control | 0 | 3.3 | 0.4 | a |
| (infested) | | | | |
| 480EC | 0.5 | 0.1 | 0.1 | e |
| 480EC | 2 | 0 | 0 | e |
| 380EW | 0.5 | 0 | 0.1 | de |
| 380EW | 2 | 0 | 0 | e |

*Galling Index 0-5 (0—No visual infestation, 5—sever infestation)
**Different letters denote statistical significance in outcome between the groups compared (p < 0.05).

TABLE 13
Effect of treatments with fluensulfone formulations
(480EC and 380EW) on the number of nematode eggs per tomato plant.

| | Concentration | Nematode | | Student t |
|---|---|---|---|---|
| | (mg A. I. /L | Eggs | St | statistical |
| Treatment | soil) | count | Dev | analysis* |
| Control | 0 | | | |
| (nematode | | | | |
| free) | | | | |
| Control | 0 | 236700 | 1816 | a |
| (infested) | | | 8 | |
| 480EC | 0.5 | 13950 | 1040 | d |
| | | | 0 | |
| 480EC | 2 | 0 | 0 | e |
| 380EW | 0.5 | 7313 | 3744 | c |
| 380EW | 2 | 0 | 0 | e |

*letters denote statistical significance in outcome between the groups compared (p < 0.05).

The treatments did not affect the fresh shoot weight of tomato plants compared to non-infested plants (Table 11). All the tested formulations (380EW and 480EC) reduced the galling index (Table 12). Both EC and EW formulations at 0.5 & 2 mg A.I./L soil reduced significantly the number of nematode eggs per plant vs. the infested control (Table 13).

At 0.5 A.I./L soil EW formulation was overall more efficient to control nematodes compared to the EC formulation.

### Conclusion

Both fluensulfone formulations (380EW and 480EC) significantly reduced the nematodes activity. The EW formulation is as effective as the EC formulation in controlling nematodes in the soil.

### Discussion of the Examples:

In an effort to create a stable high-concentration fluensulfone formulation, fluensulfone was formulated with a number of different compounds. It was found that only the addition of cyclic ketone(s) to fluensulfone allowed for a stable fluensulfone formulation with a concentration of fluensulfone in the organic phase of greater than 40% by weight.

It was surprisingly discovered that mixtures of cyclic ketone(s) with fluensulfone have a lower melting point which allows a high-concentration of solubilized fluensulfone and avoids use of large amounts of heavy organic solvents. The presence of cyclic ketone also prevents highly-concentrated fluensulfone in the spray liquor from crystallizing out.

Since the formulations of the subject invention contains a high-concentration of fluensulfone, the formulations of the subject invention can be applied at significantly reduced quantities as compared to other commercial nematicidal products which save costs and time.

In addition, since a high-concentration of fluensulfone in the organic phase is maintained in the soil after the formulation is applied, the fluensulfone can efficiently diffuse into the nematodes upon contact with the nematodes and immobilize the nematodes at contact or shortly after contact.

Further, since the fluensulfone in the formulations of the subject invention does not crystallize out, a lower application rate of fluensulfone is needed to achieve a given level of nematicidal effect. A reduction in the amount of fluensulfone needed can save costs and reduce runoffs.

Finally, the fluensulfone formulations described herein have been shown to be highly stable even after accelerated storage.

1-83. (canceled)

84. A stable liquid fluensulfone formulation comprising:
(i) an amount of fluensulfone,
(ii) an amount of a cyclic ketone, and
(iii) at least one agrochemically acceptable inert additive,
wherein the formulation comprises an organic phase, wherein the fluensulfone is dissolved in the organic phase, and wherein the concentration of the dissolved fluensulfone in the organic phase of the formulation is greater than 40% by weight based on the weight of the organic phase.

85. The formulation of claim 84, wherein the organic phase is 60% to 80% by weight based on the weight of the formulation and the concentration of the dissolved fluensulfone in the organic phase of the formulation is between 50% to 80% by weight based on the weight of the organic phase.

86. The formulation of claim 84, wherein the amount of fluensulfone in the formulation is in liquid state.

87. The formulation of claim 84, wherein the cyclic ketone is selected from a group consisting of acetophenone, cyclohexanone, N-octyl-2-pyrrolidone, and any mixture thereof.

88. The formulation of claim 84, wherein the cyclic ketone is acetophenone.

89. The formulation of claims 84, wherein:
a) the concentration of cyclic ketone in the formulation is about 1% to about 30% by weight of the total formulation or about 10 g/L to about 300 g/L of the total formulation,
b) the weight ratio of the cyclic ketone to the fluensulfone in the formulation is about 1:1 to about 1:8, and/or
c) the formulation has an organic phase which comprises 45% to 100% of the total formulation by weight.

90. The formulation of claim 84, wherein:
a) the concentration of cyclic ketone in the formulation is about 130 g/L to about 190 g/L of the total formulation,
b) the weight ratio of the cyclic ketone to the fluensulfone in the formulation, is about 1:1 to about 1:3, and/or
c) the formulation has an organic phase which comprises about 70% of the total formulation by weight.

91. The formulation of claim 84, wherein:
a) the concentration of the dissolved fluensulfone in the organic phase of the formulation is greater than 76% by weight based on the weight of the organic phase, and/or
b) the concentration of cyclic ketone in the organic phase of the formulation is about 5% to about 30% by weight based on the weight of the organic phase.

92. The formulation of claim 84, wherein the at least one agrochemically acceptable inert additive is selected from the group consisting of adjuvants, surfactants, stabilizers, polymers, thickening agents, antioxidants, antifreeze agents, antifoaming agents, colorants, ultraviolet light absorbers, antibacterial agents, salts, pH modifiers, co-solvents, humectants, and any combination thereof.

93. The formulation of claim 92, wherein:
a) the surfactant is an ionic surfactant, an anionic surfactant, or a nonionic surfactant,
b) the antifoaming agent is silicone oil, magnesium stearate or a silicone based antifoaming agent,
c) the antioxidant is butylated hydroxytoluene (2,6-di-t-butyl-4-methylphenol, BHT),
d) the colorant is selected from a group consisting of titanium dioxide, carbon black, zinc oxide, blue pigments and permanent red,
e) the antifreeze agent is selected from a group consisting of urea, glycerol and propylene glycol, and/or
f) the pH modifier is hexamethylenetetramine (HMTA).

94. The formulation of claim 93, wherein:
a) the anionic surfactant is selected from a group consisting of alkali metal and alkaline earth metal salts of alkylsulphonic acids or alkylarylsulphonic acids, salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde, salts of lignosulphonic acid, and the mixtures thereof,
b) the anionic surfactant is a block copolymer,
c) the anionic surfactant is sodium 2-acryloylamino-2-methylpropane-1-sulfonate/ethyl acrylate block copolymer,
d) the nonionic surfactant is selected from a group consisting of polyoxyethylene octyl phenol ethers, alkoxylated alcohols, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-derived sulfonates, polysaccharides, hydrophobically modified starches, silicon-based surfactants, polyvinyl alcohol and its derivatives, polyalkoxylates, polyvinylamines polyvinylpyrrolidone and their copolymers or block polymers and the mixtures thereof,
e) the nonionic surfactant is selected from a group consisting of castor oil ethylene oxides, polyvinyl alcohol) (PVA), ethylene oxide/propylene oxide block copolymers and any combination thereof, or
f) the nonionic surfactant is a castor oil ethylene oxide.

95. The formulation of claim 84, wherein:
a) the concentration of all the agrochemically acceptable inert additive(s) in the formulation is from about 5% to about 30% by weight of the total formulation or from about 5 g/L to about 30 g/L of the total formulation,
b) the formulation has a density of about 1 to about 1.5 g/mL,
c) the formulation has a pH of 4.5 to 7.5 or a pH of 5 to 8,
d) the formulation is an emulsifiable concentrate (EC), or
e) the formulation is an oil-in-water emulsion (EW).

96. The formulation of claim 84, wherein:
a. the cyclic ketone is other than acetophenone,
b. the agrochemically acceptable inert additive is other than sodium 2-acryloylamino-2-methylpropane1-sulfonate/ethyl acrylate block copolymers, or
c. the formulation is other than an oil-in-water emulsion formulation comprising 51% by weight of fluensulfone, 16.8% by weight of acetophenone, 0.4% by weight of 2, 6-di-tert-butyl-4-methylphenol, 1% by weight of castor oil ethylene oxide, 2.78% by weight of sodium 2-acryloylamino-2-methylpropane-1-sulfonate/ethyl acrylate block copolymer, 2.78% by weight of ethoxylated polypropylene oxide, 2.2% by weight of propylene glycol, 0.1% by weight of silicone based antifoaming agent and 23% by weight of water.

97. A method of controlling a pest comprising applying the fluensulfone formulation of claim 84 to the pest, juveniles of the pest, or eggs or cysts of the pest, or to a medium on which the pest, the juveniles of the pest or the eggs or cysts of the pest is capable of being present thereby controlling the pest.

98. The method of claim 97, wherein:
a. the formulation is effective to kill the pest, the juvenile of the pest, or the egg or cyst of the pest,
b. the formulation is effective to improve growth of plants infested with nematodes treated with the fluensulfone formulation compared to growth of untreated plants infested with nematodes, and/or
c. the formulation is effective to improve root health of plants infested with nematodes treated with the fluensulfone formulation compared to growth of untreated plants, infested with nematodes.

99. The method of claim 97, wherein the formulation is applied at a rate from about 0.01 kg/ha to about 8 kg/ha of fluensulfone or from about 1 g to about 50 g of fluensulfone per 100 kg of seeds.

100. A process of preparing the stable liquid formulation of claim 84, wherein the process comprises the steps of:
a) preparing a homogenous mixture comprising the amount of fluensulfone and the amount of the cyclic ketone, and
b) mixing the homogenous mixture with the agrochemically acceptable inert additive to form a stable liquid fluensulfone formulation.

101. The process of claim 100, wherein the formulation is a stable oil-in-water emulsion formulation wherein the process comprises the steps of:
(a) preparing a first homogenous mixture comprising the amount of fluensulfone and the amount of a cyclic ketone,
(b) preparing a second homogenous mixture comprising water and the at least one agrochemically acceptable inert additive, and
(c) mixing the first homogenous mixture and the second homogenous mixture to form an oil-in-water emulsion fluensulfone formulation.

102. The process of claims 101, wherein:
a) step (i) is performed at a temperature between 45° C. to 50° C.,
b) the first homogenous mixture further comprises an antioxidant,
c) the first homogenous mixture further comprises a nonionic surfactant,
d) step (ii) is performed at a temperature between 80° C. to 85° C.,
e) the agrochemically acceptable inert additive is an emulsifier, an antifreeze agent, an antifoam agent, and/or a pH modifier, and/or
f) step (iii) is performed under high shear.

103. The process of claim 101, wherein the fluensulfone is liquefied during the process of preparation of the formulation.
